(19) United States
(12) Patent Application Publication
(10) Pub. No.: US 2021/0330115 A1
(43) Pub. Date: Oct. 28, 2021

(54) Fountain-type Brewing Device with Automatic Water Supply Function

(71) Applicant: Shenzhen Her Smart House Technology Co., Ltd., Shenzhen (CN)

(72) Inventors: Xiangning Yang, Shenzhen (CN); Huahui Lin, Shenzhen (CN)

(73) Assignee: Shenzhen Her Smart House Technology Co., Ltd.

(21) Appl. No.: 17/369,969

(22) Filed: Jul. 8, 2021

(30) Foreign Application Priority Data
Feb. 2, 2021 (CN) 20211039012.2

(51) Int. Cl. A47J 31/06; A47J 31/20; A47J 31/44

(52) U.S. Cl. CPC A47J 31/0615; A47J 31/4439; A47J 31/20

(57) ABSTRACT

A fountain-type brewing device with an automatic water supply function comprises a device body provided with a brewing container and a brewing frame. A main passage and a branched passage are disposed in the brewing frame. A brewing basket is disposed on the brewing frame. The brewing frame is provided with a guide rod located above the brewing basket. The guide rod is provided with a guide cavity communicated with the branched passage, and a water outlet of the guide cavity is exactly opposite to a pipe outlet of the main passage. A water pump is disposed in the device body and is provided with a water inlet disposed in the brewing container and a water outlet communicated with the main passage via a drain joint.

### BACKGROUND OF THE INVENTION

### 1. Technical Field

The invention relates to the technical field of brewing devices, in particular to a fountain-type brewing device with an automatic water supply function.

### 2. Description of Related Art

As is commonly known, people use brewing devices when drinking tea, milk powder and coffee in daily life. Wherein, tea brewing devices are the most common ones, most of which adopt a brewing basket to contain tea or other substances to be brewed, and the brewing basket rises and falls in water to brew tea or other substances; however, such a brewing manner often leads to non-uniform brewing. Some of these brewing devices adopt a rotary motor sleeved with an impeller stirring head for stirring to make brewing more uniform; however, it is extremely inconvenient for users to clean such brewing devices.

### BRIEF SUMMARY OF THE INVENTION

In view of the defects of the prior art, the objective of the invention is to provide a fountain-type brewing device with an automatic water supply function.

To fulfill the aforesaid objective, the invention adopts the following technical solution:

A fountain-type brewing device with an automatic water supply function comprises a device body, wherein the device body is provided with a brewing container, a brewing frame is mounted in the brewing container by means of a locking element, a main passage and at least one branched passage communicated with the main passage are disposed in the brewing frame, a brewing basket is disposed on the brewing frame, a pipe outlet of the main passage is disposed in the brewing basket, the brewing frame is provided with a guide rod located above the brewing basket, the guide rod is formed with a guide cavity communicated with the branched passage, and a water outlet of the guide cavity is exactly opposite to the pipe outlet of the main passage; and a circuit board, a heating plate, a power connector and a water pump are disposed in the device body, the heating plate, the power connector and the water pump are all electrically connected to the circuit board, the heating plate is disposed at the bottom of the brewing container, a water inlet of the water pump is disposed in the brewing container, and a water outlet of the water pump is communicated with the main passage via a drain joint.

Preferably, the locking element is a magnet, a buckle, or a thread.

Preferably, the guide rod is provided with a barrier plate located at the water outlet of the guide cavity.

Preferably, the device body is provided with a control switch electrically connected to the circuit board.

Preferably, a filter screen or a filter paper is disposed on the periphery or the bottom of the brewing basket.

Preferably, a temperature sensor is disposed in the brewing container and is electrically connected to the circuit board.

Preferably, the device body is provided with a lid located at a cavity opening of the brewing container.

Preferably, the device body is provided with a handle to be held by users.

Preferably, the device body is further provided with an induction switch for detecting whether the brewing frame has been assembled, and the induction switch is electrically connected to the circuit board.

By adoption of the above solution, the brewing frame of the invention is provided with two discharge passages, one of which is consisted of the main passage and the other one is consisted of the branched passage and the guide cavity in the guide rod, water outlets of the two discharge passages are exactly opposite to each other, and water sprayed out of the two discharge passages under the effect of the water pump form water columns that collide with each other to form a horizontal spraying surface, which creates a fountain effect to allow water to be evenly sprinkled into the brewing basket, so that a fountain-type uniform brewing effect is realized.

### BRIEF DESCRIPTION OF THE SEVERAL VIEWS OF THE DRAWINGS

FIG. 1 is a structural principle diagram of Embodiment 1 of the invention.

FIG. 2 is a perspective structural view of a brewing frame in Embodiment 1 of the invention.

FIG. 3 is a sectional view of the brewing frame in Embodiment 1 of the invention.

FIG. 4 is a structural diagram of Embodiment 2 of the invention.

FIG. 5 is a structural diagram of Embodiment 3 of the invention.

FIG. 6 is a structural diagram of Embodiment 4 of the invention.

FIG. 7 is a structural diagram of Embodiment 5 of the invention.

### DETAILED DESCRIPTION OF THE INVENTION

The embodiments of the invention will be described in detail below in conjunction with the accompanying drawings. Clearly, the invention may be implemented in different manners defined and covered by the claims.

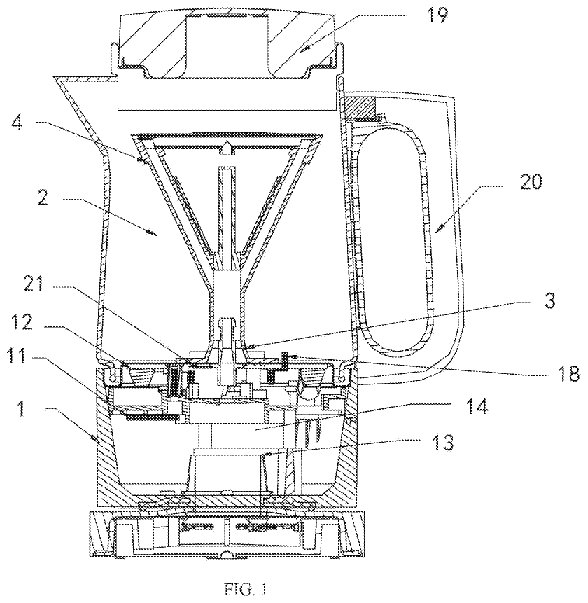

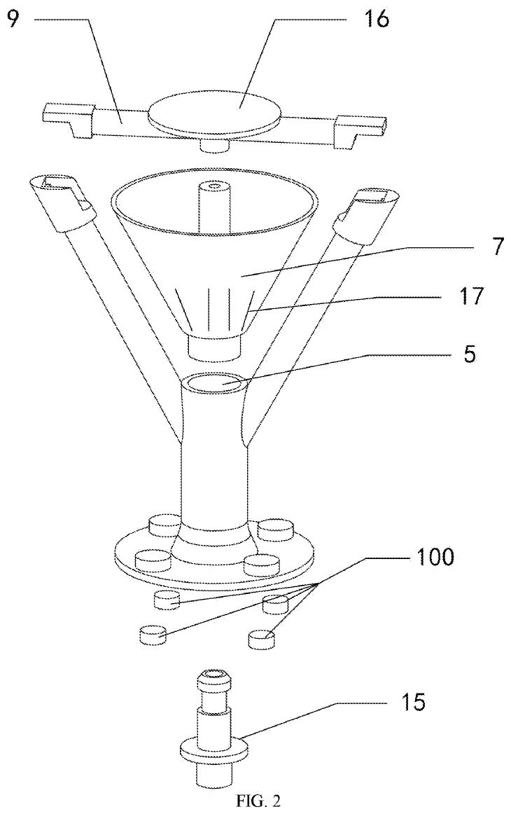

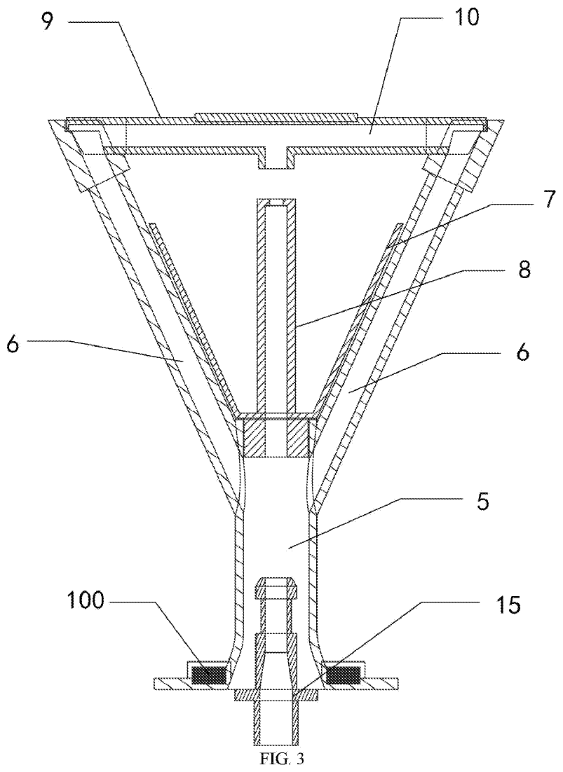

As shown in FIG. 1 to FIG. 7, the invention has multiple embodiments:

Embodiment 1: This embodiment provides a fountain-type brewing device with an automatic water supply function, comprising a device body 1, wherein the device body 1 is provided with a brewing container 2, a brewing frame 4 is mounted in the brewing container 2 by means of a locking element 3, a main passage 5 and at least one branched passage 6 communicated with the main passage 5 are disposed in the brewing frame 4, a brewing basket 7 is disposed on the brewing frame 4, a pipe outlet 8 of the main passage 5 is disposed in the brewing basket 7, the brewing frame 4 is provided with a guide rod 9 located above the brewing basket 7, the guide rod 9 is provided with a guide cavity 10 communicated with the branched passage 6, and a water outlet of the guide cavity 10 is exactly opposite to the pipe outlet 8 of the main passage 5; and a circuit board 11, a heating plate 12, a power connector 13 and a water pump 14 are disposed in the device body 1, the heating plate 12, the power connector 13 and the water pump 14 are all electrically connected to the circuit board 11, the heating plate 12 is disposed at the bottom of the brewing container 2, a water inlet of the water pump 14 is disposed in the brewing container 2, a water outlet of the water pump 14 is communicated with the main passage 5 by means of a drain joint 15.

The brewing principle of this embodiment mainly lies in that a jet brewing effect is realized by means of opposed water columns. Specifically, when the fountain-type brewing device works, water is injected into the brewing container 2 at first, the power connector 13 is connected to a power source, and the circuit board 11 controls the heating plate 12 to generate heat to heat the water in the brewing container 2; when heated to a preset system temperature, the water in the brewing container 2 will not be heated anymore. The water in the brewing container 2 is pumped and discharged by the water pump 14 into the main passage 5 of the brewing frame 4, part of the water discharged by the water pump 14 flows into the at least one branched passage 6 disposed in the main passage 5, and in this way, the brewing frame 4 is divided into two discharge passages, one of which is consisted of the main passage 5 and the other one is consisted of the branched passage 6 and the guide cavity 10 in the guide rod 9; water in the main passage 5 is sprayed out directly, while water in the branched passage 6 is sprayed out via the guide cavity 10 in the guide rod 9, and the water outlet of the guide cavity 10 is exactly opposite to the pipe outlet 8 of the main passage 5, so water sprayed out of the main passage 5 collides with water sprayed out of the branched passage 6 to form a horizontal spraying surface, which creates a fountain effect to allow water to be evenly sprinkled into the brewing basket 7, thus realizing a fountain-type uniform brewing effect. Water in the brewing basket 7 flows into the brewing container 2 again after flushing the brewing basket 7, water is continuously pumped from the brewing container 2 by the water pump 14 to be used for flushing again to realize cyclic flushing, and finally, uniform and sufficient brewing is completed.

Further, in this embodiment, the brewing frame 4 is detachably mounted in the brewing container 2, and specifically, the brewing frame 4 is locked by the locking element 3. However, the locking element 3 in this embodiment may be of different structures. For example, the locking element 3 may be a magnet 100 for attracting the brewing frame 4 into the brewing container 2, or the locking element 3 may be a buckle for clamping and locking the brewing frame 4 into the brewing container 2, or the locking element 3 may be an internal or external thread for rotatably screwing the brewing frame 4 into the brewing container 2. This embodiment has no limitation in this aspect. The brewing frame 4 is detachably mounted in the brewing container 2, so that brewing frames 2 of different structures may be used when necessary and may be detached to be cleaned.

Further, to prevent other portions of the device body from being contaminated by part of liquid splashing upwards when the water columns collide with each other, the guide rod 9 in this embodiment is provided with a barrier plate 16 located at the water outlet of the guide cavity 10. The barrier plate 16 is able to prevent water from splashing upwards, thus fulfilling a protection effect.

Further, to ensure that users can perform actual operation control easily, the device body 1 in this embodiment is provided with a control switch (not shown) electrically connected to the circuit board 11. Users may press the control switch to transmit instructions to the circuit board 11 to start work.

Further, to prevent large particles from entering the brewing container 2, a filter screen 17 or a filter paper is disposed on the periphery or the bottom of the brewing basket 7 to filter brewed substances, in this embodiment.

Further, to accurately control the water temperature, a temperature sensor 18 is disposed in the brewing container 2 and is electrically connected to the circuit board 11, in this embodiment; and when detecting a set parameter value, the temperature sensor 18 sends an instruction to the circuit board to stop the heating plate from generating heat.

Further, to guarantee normal use of the brewing device, the device body 1 in this embodiment is provided with a lid 19 located at a cavity opening of the brewing container 2 and is also provided with a handle 20 to be held by users.

Further, considering that hot water in the brewing device may splash out because the water pump 14 starts to work before the brewing frame 4 is assembled, the device body 1 in this embodiment is further provided with an induction switch 21 for detecting whether the brewing frame 4 has been assembled, the induction switch 21 is electrically connected to the circuit board 11, and the water pump 14 will not start to work until the induction switch 21 senses that the brewing frame 4 has been assembled. Since the brewing frame 4 is mounted in the brewing container 2 by means of the locking element 3 and the locking element 3 may be mounted in different manners, the induction switch 21 in this embodiment needs to be matched with the installation structure of the locking element 3. For example, if the locking element 3 is a magnet, a Hall switch is used to detect whether the brewing frame 4 has been assembled; or, if the locking element 3 is a buckle or a thread, a micro-switch may be used to detect whether the brewing frame 4 has been assembled. This embodiment has no limitation to the specific type of the induction switch 21.

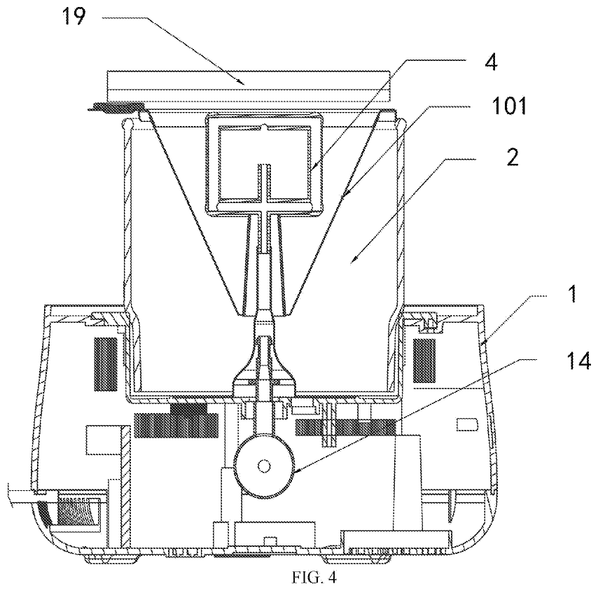

Embodiment 2: As shown in FIG. 4, to facilitate coffee brewing, the periphery of the brewing frame 4 is sleeved with a coffee basket 101, the bottom of the coffee basket 101 is disposed around the brewing frame 4, the brewing basket 7 is disposed inside the coffee basket 101, and the upper end of the coffee basket 101 is connected to the cavity opening of the brewing container 2. When the brewing device is used for brewing coffee, coffee powder is brewed in a fountain manner and is then filtered by the coffee basket 101, so that coffee brewing requirements are met.

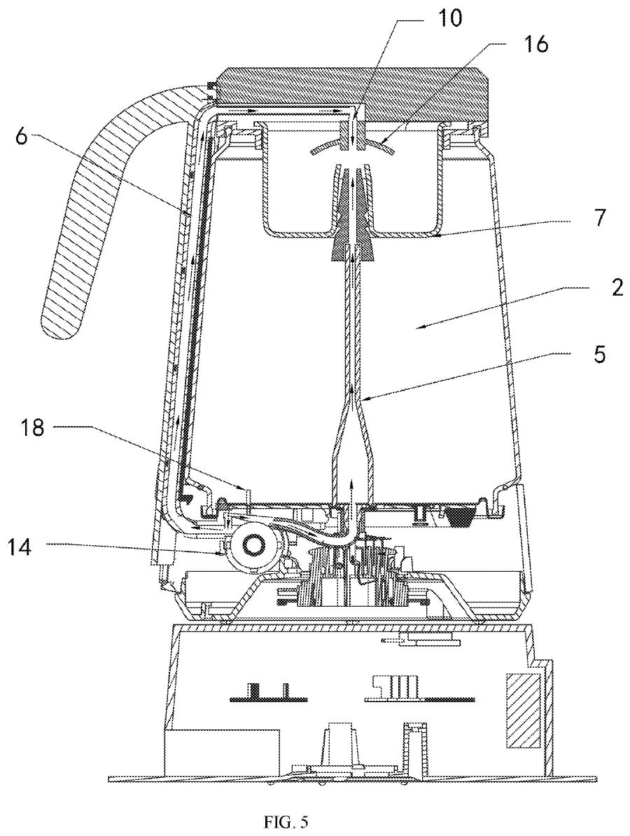

Embodiment 3: As shown in FIG. 5, the branched passage 6 in Embodiment 1 is formed in an inner wall of the device body 1, and the guide cavity 10 in Embodiment 1 is formed in the lid 19; in this embodiment, the branched passage 6 is still communicated with the guide cavity 10, so that when the water pump 14 pumps water, water out of the water outlet of the water pump 14 is divided into two paths, one of which enters the branched passage 6 in the inner wall of the device body 1 and the other one enters the main passage 5, and the two paths of water collide with each other eventually.

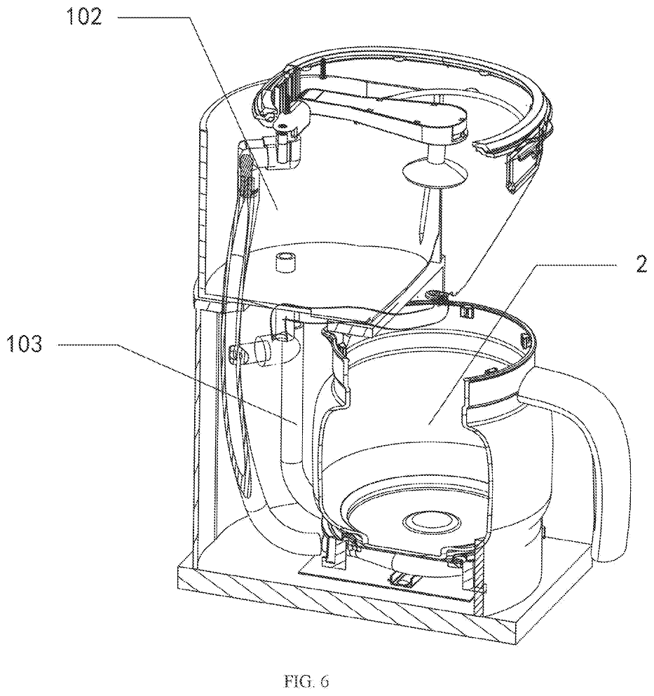

Embodiment 4: As shown in FIG. 6, on the basis of embodiment 1, the device body 1 is further provided with a water chamber 102 communicated with the brewing container 2 by means of a hose 103, and the water chamber 102 is higher than the brewing container 2, so that when water is added into the water chamber 102, the water automatically flows into the brewing container 2 to be used.

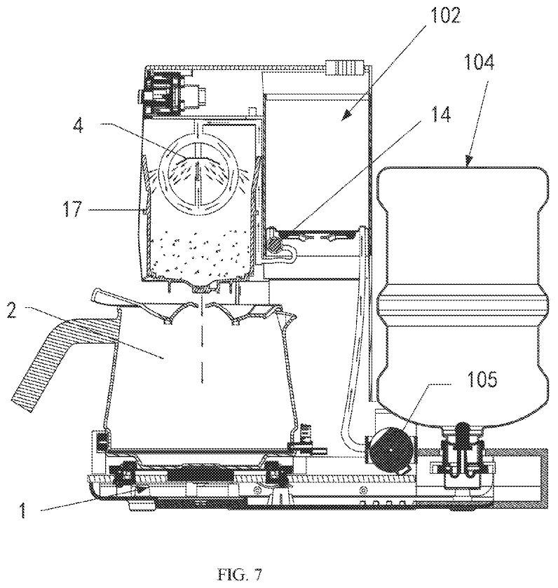

Embodiment 5: As shown in FIG. 7, based on the principle of Embodiment 4, a water supply body 104 (such as a water tank or a bucket) is detachably mounted on the device body 1, a water pump 105 is additionally arranged to guide water in the water supply body 104 into the water chamber 102, a solution flowing into the brewing container 2 will not be pumped by the water pump 14 be brewed again, and the water pump 14 only pumps water from the water chamber 102, so this embodiment is suitable for drinks requiring one time of brewing.

The aforesaid embodiments are merely preferred ones of the invention, and are not intended to limit the patent scope of the invention. All equivalent structural transformations or flow transformations made according to the contents of the specification and the accompanying drawings, or direct or indirect applications to other relating technical fields should also fall within the protection scope of the patent of invention.

What is claimed is:

1. A fountain-type brewing device with an automatic water supply function, comprising a device body, wherein the device body is provided with a brewing container, a brewing frame is mounted in the brewing container by means of a locking element, a main passage and at least one branched passage communicated with the main passage are disposed in the brewing frame, a brewing basket is disposed on the brewing frame, a pipe outlet of the main passage is disposed in the brewing basket, the brewing frame is provided with a guide rod located above the brewing basket, the guide rod is formed with a guide cavity communicated with the branched passage, and a water outlet of the guide cavity is exactly opposite to the pipe outlet of the main passage; and a circuit board, a heating plate, a power connector and a water pump are disposed in the device body, the heating plate, the power connector and the water pump are all electrically connected to the circuit board, the heating plate is disposed at a bottom of the brewing container, a water inlet of the water pump is disposed in the brewing container, and a water outlet of the water pump is communicated with the main passage via a drain joint.

2. The fountain-type brewing device with an automatic water supply function according to claim 1, wherein the locking element is a magnet, a buckle, or a thread.

3. The fountain-type brewing device with an automatic water supply function according to claim 2, wherein the guide rod is provided with a barrier plate located at the water outlet of the guide cavity.

4. The fountain-type brewing device with an automatic water supply function according to claim 3, wherein the device body is provided with a control switch electrically connected to the circuit board.

5. The fountain-type brewing device with an automatic water supply function according to claim 3, wherein a filter screen or a filter paper is disposed on a periphery or a bottom of the brewing basket.

6. The fountain-type brewing device with an automatic water supply function according to claim 5, wherein a temperature sensor is disposed in the brewing container and is electrically connected to the circuit board.

7. The fountain-type brewing device with an automatic water supply function according to claim 6, wherein the device body is provided with a lid located at a cavity opening of the brewing container.

8. The fountain-type brewing device with an automatic water supply function according to claim 7, wherein the device body is provided with a handle to be held by users.

9. The fountain-type brewing device with an automatic water supply function according to claim 2, wherein the device body is further provided with an induction switch for detecting whether the brewing frame has been assembled, and the induction switch is electrically connected to the circuit board.
